(19) United States
(12) Patent Application Publication
(10) Pub. No.: US 2010/0177942 A1
(43) Pub. Date: Jul. 15, 2010

(54) METHOD AND APPARATUS FOR ANALYZING IMAGERY DATA

(75) Inventors: Tsafrir KOLATT, Haifa (IL); Elior Shenhav, Haifa (IL)

Correspondence Address: MARTIN D. MOYNIHAN d/b/a PRTSI, INC., P.O. BOX 16446, ARLINGTON, VA, 22215, US

(73) Assignee: Applied Spectral Imaging Ltd., Migdal HaEmek (IL)

(21) Appl. No.: 12/687,169

(22) Filed: Jan. 14, 2010

Related U.S. Application Data
(60) Provisional application No. 61/193,976, filed on Jan. 14, 2009.

(51) Int. Cl. G06K 9/00

(52) U.S. Cl. 382/128

(57) ABSTRACT

According to an aspect of some embodiments of the present invention there is provided a method of analyzing imagery data pertaining to a biological sample. the method comprises: identifying structures of biological elements in the imagery data based on achromatic intensity values of the imagery data, and displaying the imagery data as a color-coded image.

### RELATED APPLICATION

This application claims the benefit of priority of U.S. Provisional Patent Application No. 61/193,976 filed on Jan. 14, 2009, the contents of which are incorporated herein by reference.

### FIELD AND BACKGROUND OF THE INVENTION

The present invention, in some embodiments thereof, relates to image processing and, more particularly, but not exclusively, to a method and apparatus for analyzing imagery data pertaining to a biological sample.

Biological samples, such as individual cells in a smear, body fluid or cell block (cytology specimens) and cell aggregates that form a structure with a specific function (histology specimens), are oftentimes analyzed by subjecting them to a staining procedure followed by an optical examination procedure (e.g., visible light imaging). This analysis is currently applied in many life-science fields, including, histology, microbiology, cytology, cytogenetics and many other fields.

Generally, there are two types of staining procedure in the field of biology or biomedicine: global staining and target-specific staining.

In global staining, a global feature of the stained material is taken into consideration. The different manifestation of the feature is translated to different specimen appearances. This type of staining is typical, e.g., in histology, where a specimen is processed and applied to a microscope slide and then stained to make the normally transparent cells brilliantly colored for easier observation and to distinguish the various cellular elements which have differing affinities for different stains. For example, Hematoxylin and Eosin (H&E) staining reflects the acidity-basophilic nature of the specimen elements; Giemza staining differentiates chromosomes, cytology specimens and some bacteria; Fuchsin staining enhances collagen, smooth muscle and mitochondria; etc. Since every chemical entity bears, e.g., an acidity value, this type of staining does not target specific compounds. Its benefits are judged by its ability to differentiate the elements-of-interest from the background or from other elements.

In target-specific staining, on the other hand, the stains bind to specific target in the sample. The specific target can be a protein, a chromosomal sequence or any other object, e.g., a mycobacterium or the like. This type of staining is typical, e.g., in immunohistochemistry (also referred to as immunocytochemistry), where spectrally marked antibodies are applied to the specimen to detect specific protein manifestations within the tissue thereby to obtain higher level of resolution compared to histology staining and information regarding their functionality. Such markers have diagnostic significance and in some cases (e.g., in breast cancer) also prognostic significance. This type of staining is typical also in fluorescent in-situ hybridization (FISH), in which a ratio of fluorescent dots with respect to control set of differently colored dots is used to quantify the tissue condition. Other target-specific staining techniques include variants of the FISH (e.g., M-ISH, CISH, ISH, etc.) and the like.

In target-specific staining the same dye is suitable for many different targets through binding and thus its meaning depends on the specimen context. Examples for known dyes suitable for target-specific staining include, Diamino Benzidine tetrahydrochlorid (DAB), 3-Amino-9-ethylcarbazole (AEC) and Fast-Red. A prototype suitable for the case of bacteria specific staining is the Ziehl-Nielsen (Methylene blue and fuchsine) staining for bacilli.

It is recognized that in traditional techniques for analyzing biological samples, the samples have to be stained prior to the optical examination procedure. This is because many features in the biological sample are visually unidentifiable without the aid of global or target-specific staining.

### SUMMARY OF THE INVENTION

According to an aspect of some embodiments of the present invention there is provided a method of analyzing imagery data pertaining to a biological sample. the method comprises: identifying structures of biological elements in the imagery data based on achromatic intensity values of the imagery data, and displaying the imagery data as a color-coded image.

According to some embodiments of the invention the method further comprising acquiring an achromatic image of a biological sample, thereby providing the imagery data.

According to an aspect of some embodiments of the present invention there is provided apparatus for analyzing imagery data pertaining to a biological sample. the apparatus comprises: a structure identification unit, for identifying structures of biological elements in the imagery data based on achromatic intensity values of the imagery data, and an output unit being associated with a display device and configured for displaying the imagery data as a color-coded image on the display device.

According to an aspect of some embodiments of the present invention there is provided an imaging system. The imaging system can comprise an imaging apparatus configured for acquiring an achromatic image of a biological sample, and an image analysis apparatus which receives and analyze imagery data from the imaging system. The image analysis apparatus can comprise a structure identification unit, and an output unit as further detailed herein.

According to an aspect of some embodiments of the present invention there is provided a microscope system, comprising a microscope device for providing a user with an enlarged view of a scene and an image analysis apparatus which receives and analyze imagery data from the microscope device and transmits a color-coded image to an eyepiece of the microscope device in a manner such that the color-coded image superimposes the view of said scene. The image analysis apparatus can comprise a structure identification unit, and an output unit as further detailed herein.

According to some embodiments of the invention the output unit is configured to apply coordinate transformation to the color-coded image synchronously with a motion of a stage of the microscope device.

According to some embodiments of the invention at least two different types of biological elements in the color-coded image are presented in different colors.

According to some embodiments of the invention the identification of the structures comprises identifying a structure of at least one biological element that would have been enhanced had the biological sample been stained.

According to some embodiments of the invention the identification of the structures comprises identifying a structure of at least one biological element which is stainable by a target-specific stain.

According to some embodiments of the invention the identification of the structures is based on morphology and orientations of groups of picture-elements in the imagery data.

According to some embodiments of the invention the identification of the structures is based on non-local comparison between groups of picture-elements in the imagery data

According to some embodiments of the invention the identification of the structures is based on moments of the intensity distribution among groups of picture-elements in the imagery data.

According to some embodiments of the invention the identification of the structures is based on intensity smoothness among groups of picture-elements in the imagery data.

According to some embodiments of the invention the identification of the structures is based on intensity gradients among groups of picture-elements in the imagery data.

According to some embodiments of the invention the identification of the structures is based on comparison of shapes formed by group of picture-elements in the imagery data to reference shapes of biological elements.

According to some embodiments of the invention the reference shapes are obtained from a library of shapes.

According to some embodiments of the invention the reference shapes are obtained from reference imagery data corresponding to a reference image.

According to some embodiments of the invention the method further comprises extracting the reference shapes from the reference imagery data.

According to some embodiments of the invention the method further comprises capturing the reference image.

According to some embodiments of the invention the identification of the structures comprises at least one procedure selected from the group consisting of: edge detection, local edge enhancement, clustering, upwind scheme discretization and fast marching.

According to some embodiments of the invention the method further comprises obtaining additional imagery data and using the additional imagery data for correcting the identification of the structures.

According to some embodiments of the invention the additional imagery data comprises phase microscopy imagery data.

According to some embodiments of the invention the additional imagery data comprises dark field imagery data.

According to some embodiments of the invention the additional imagery data comprises inverted microscopy imagery data.

According to some embodiments of the invention the additional imagery data comprises imagery data captured following staining of the biological sample, and wherein the identification of the structures comprises identifying a structure of at least one biological element which is not enhanced or targeted by the staining.

According to some embodiments of the invention the method further comprises capturing an image of the biological sample so as to provide the additional imagery data.

According to some embodiments of the invention the color-coded image is displayed at a magnification level which is higher than a magnification at which the identification of the structures is performed.

According to some embodiments of the invention the color-coded image is displayed together with an image captured following staining of the biological sample in a superimposed manner and at the same magnification level.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings and images. With specific reference now to the drawings and images in detail, it is stressed that the particulars shown are by way of example and for purposes of illustrative discussion of embodiments of the invention. In this regard, the description taken with the drawings and images makes apparent to those skilled in the art how embodiments of the invention may be practiced.

In the drawings:

FIG. 1 is a flowchart diagram of a method suitable for analyzing imagery data pertaining to a biological sample, according to various exemplary embodiments of the present invention;

FIG. 2 is a grey-scale transmission image of a paraffin embedded breast tissue specimen;

FIG. 3 is a color image of a serial section of the specimen of FIG. 2 following staining by Hematoxylin and Eosin (H&E);

FIG. 4 is scatter plot demonstrating pixel intensity mapping between the grey-scale image and the color image;

FIG. 5 is a grey-scale image of the same tissue shown in FIG. 2, but captured with a color imaging device;

FIG. 6 is a color-coded image in which the imagery data corresponding to FIG. 2 is displayed such that different types of biological elements are presented in different colors;

FIG. 7 is a phase image of the breast tissue sample of FIG. 2, as acquired using a U-PCD2, OLYMPUS Phase contrast condenser annular ring No. I;

FIG. 8 is a phase image of the breast tissue sample of FIG. 2, as acquired using a U-PCD2, OLYMPUS Phase contrast condenser annular ring No. II;

FIG. 9 is a phase image of the breast tissue sample of FIG. 2, as acquired using a U-PCD2, OLYMPUS Phase contrast condenser annular ring No. III;

FIG. 10 is a scatter plot demonstrating the relation between pixel intensities in a grey-scale image and the pixel intensities in a phase image

FIG. 11 is an illustrative example of an embodiment in which imagery data corresponding to FIGS. 7 and 8 is combined with input data to provide a color coded-image;

FIG. 12 is an illustrative example of another embodiment in which imagery data corresponding to FIGS. 7 and 8 is combined with input data to provide a color coded-image;

FIG. 13 is a flowchart diagram describing a procedure for combining information acquired from staining with information acquired from achromatic imagery data, according to various exemplary embodiments of the present invention;

FIG. 14 is a schematic illustration of an apparatus for analyzing imagery data pertaining to a biological sample, according to various exemplary embodiments of the present invention;

FIG. 15 is a schematic illustration of an imaging system, according to various exemplary embodiments of the present invention; and

FIG. 16 is a schematic illustration of microscope system, according to various exemplary embodiments of the present invention;

### DESCRIPTION OF SPECIFIC EMBODIMENTS OF THE INVENTION

The present invention, in some embodiments thereof, relates to image processing and, more particularly, but not exclusively, to a method and apparatus for analyzing imagery data pertaining to a biological sample. Some embodiments of the present invention comprise an imaging system which is capable of capturing an image and analyzing imagery data associated with the image.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

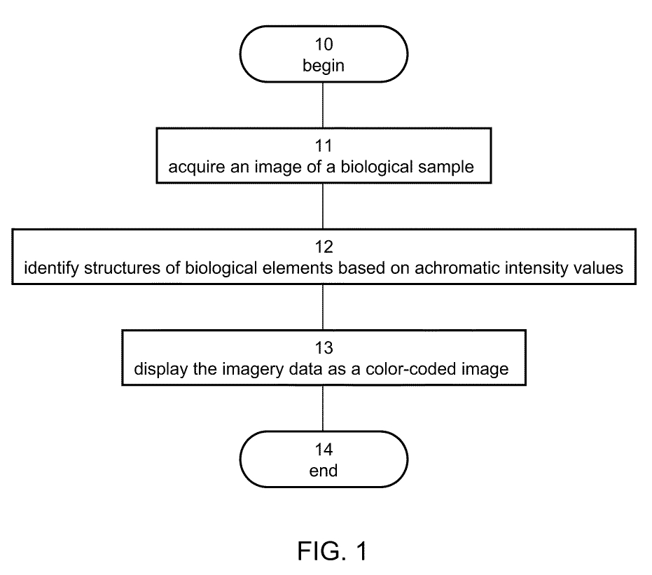

Referring now to the drawings, FIG. 1 is a flowchart diagram of a method suitable for analyzing imagery data pertaining to a biological sample, according to various exemplary embodiments of the present invention.

It is to be understood that, unless otherwise defined, the operations described hereinbelow can be executed either contemporaneously or sequentially in many combinations or orders of execution. Specifically, the ordering of the flowchart diagram is not to be considered as limiting. For example, two or more operations, appearing in the following description or in the flowchart diagram in a particular order, can be executed in a different order (e.g., a reverse order) or substantially contemporaneously. Additionally, several operations described below are optional and may not be executed.

The imagery data on which the method of the present embodiments operates correspond to an image of the biological sample. The imagery data can be prepared in advanced or acquired by the method by employing an imaging technique. Generally, the imagery data is arranged gridwise in a plurality of picture-elements (e.g., pixels, group of pixels, etc.), respectively representing a plurality of spatial locations of the biological sample. The spatial locations can be arranged over the biological sample using a two-dimensional coordinate system to provide an image characterized by two spatial dimensions. Each picture-element of the image is associated with an intensity value or a grey-level.

It is appreciated that the number of different intensity values can be different from the number of grey-levels. For example, an 8-bit display can generate 256 different grey-levels. However, in principle, the number of different intensity values corresponding to optical information acquired from the biological sample can be much larger. For example, commercially available digital imaging devices based upon CCD detector arrays are known to acquire image information across a wide range of intensity values, typically of the order of more that 2 orders of magnitude.

In some embodiments of the present invention the method processes intensity values, and in some embodiments of the present invention the method processes grey-levels. Combinations of the two (such as double processing) are also contemplated. Without loss of generality, the following description is presented with reference to intensity values. However, a more detailed reference to intensity values is not to be interpreted as excluding the processing of grey levels.

It is to be understood that references to an “image” herein are references to values (grey-levels or intensities) at picture elements, treated collectively, as an array. Thus, the term “image” as used herein includes a collection of picture-element, and does not necessarily correspond to a physical image, although the imagery data certainly do correspond to physical images.

The method begins at 10 and optionally and preferably continues to 11 at which an image of a biological sample acquired to provide the imagery data. Alternatively, imagery data corresponding to an image of the biological sample can be inputted from an external source (e.g., a memory medium). In various exemplary embodiments of the invention the imagery data is achromatic.

As used herein, “achromatic imagery data” refers to imagery data wherein each picture-element is associated with a single value representing intensity or a grey-level.

The imagery data can also correspond to a set of images wherein each image of the set corresponds to a different portion of the biological sample, a different magnification, a different illumination scheme and the like. The terms “image” and “set of images” are interchangeably used in this document. In most cases the term “image” is used to indicate a set of images, however, this is not intended to limit the scope of the present invention, which embraces the use of any number of images.

The use of set of images has the advantage of increasing the amount of information which can be extracted from the imagery data. Different magnification levels can be used for unveiling different types of hidden structures in the biological sample. This is because different types of structures oftentimes involve different resolution levels. For example, low magnification level can be used for determining global symmetries or non-local symmetries within the specimen, and higher magnification levels can be used for determining short-range correlations. In various exemplary embodiments of the invention at least a portion of the imagery data corresponds to an image at a higher magnification level. For example, the virtual staining can be is performed at a 10× magnification and then used on a 40× or 60× magnification level of the same region or part thereof.

The method continues to 12 at which structures of biological elements in the imagery data are identified based on achromatic intensity values of the imagery data, and 13 at which the imagery data is displayed as a color-coded image, such that at least two different types of biological elements are presented in different colors. Preferably, the method detects the boundary of each identified structure and uses the detected boundary for adding color information to the imagery data, such that when the data are displayed on a display device, the color or hue in a region enclosed or partially enclosed by a boundary differs from the color or hue outside the boundary. The color information can be added to the imagery data pixel-wise. For example, a CIE XYZ of CIE xyY color coordinate system can be employed, wherein each pixel or picture-element is associated with three values (in the present example, X, Y and Z or x, y and Y). Prior to the transmission of the imagery data to a display device, the color coordinates of each picture-element can be transformed to a suitable color model or color space, such as, but not limited to, RGB, CYMK, and the like.

The method ends at 14.

Before providing a further description of the method in accordance with the present embodiments, attention will be given to the advantages and potential applications offered thereby.

It is recognized that traditional staining procedures are vital in order to reveal the content and structure of a biological sample. However, staining procedures oftentimes conflict with other needs, such as minimal exposure to chemicals and light, live cell inspection, preparation speed, etc. The staining procedures may also suffer from limited lifetime of the staining agent, variations in appearance and fadeout over time. Changes due to alterations in the physical and chemical (e.g., temperature, acidity) environment are also possible. Additionally, the use of a particular staining procedure for identifying one type of biological structure may prevent the use of another staining procedure for identifying another type of structure. This is because different stains or procedure may interfere with each other.

The present embodiments successfully allow the identification of biological structures in a non-stained biological sample. The present embodiments are particularly useful in cases in which staining contradicts other processes or goals. For example, the present embodiments can be employed for analyzing images of fixated pathology specimen, that do not allow in-vivo inspection. The present embodiments can also be employed when the conditions do not permit staining or co-existence of several stains, for example, when the biological sample is at extreme temperatures or when the acidity of the biological sample is insufficient for staining.

The method of the present embodiments can also be employed as a supplementary procedure for analyzing the biological sample. This is particularly useful when a staining procedure enhances some structures but suppresses other structures, but it is desired to reveal the enhanced as well as the suppressed structures. For example, when a tissue sample is tagged by FISH, the morphology of the tissue is absent from the FISH specimen due to the lack of staining agents. The present embodiments can be used for presenting FISH signals as well as morphological features.

The method of the present embodiments can process imagery data which pertain to any type of biological sample, including, without limitation, a tissue section, a cytology specimen and a blood sample.

The method of the present embodiments preferably identifies a structure of at least one biological element that would have been enhanced had the biological sample been stained. Preferably, the method can distinguish between structures of biological matters that response differently to a staining procedure.

As used herein in the specification and in the claims section below, the term “stained” or “staining” refers to a process in which coloration is produced by foreign matter, having penetrated into and/or interacted with the biological sample. Such foreign matter is referred to hereinafter as a stain.

The stain can be of any type which is suitable to produce coloring in the biological sample. The stain can be either a global stain or a target-specific stain. Representative examples of stains include, without limitation, immunohistochemical stain, a histological stain, a DNA ploidy stain, nucleic acid (DNA or RNA) sequence specific probes (from single locus, gene or EST sequence to whole chromosome or chromosomes paints) or any combination thereof. The histological stain can be, for example, Hematoxylin-Eosin stain, Giemsa stains of different types (Romanowsky-Giemsa, May-Grunwald-Giemsa, etc.), Masson's trichrome, Papanicolaou stain and the like.

As used herein in the specification and in the claims section below, the term “stain” or “stains” refers to colorants, either fluorescent, luminescent and/or non-fluorescent (chromogenes) and further to reagents or matter used for effecting coloration.

As used herein in the specification and in the claims section below, the term “immunohistochemical stain” refers to colorants, reactions and associated reagents in which a primary antibody which binds a cytological marker is used to directly or indirectly (via “sandwich” reagents and/or an enzymatic reaction) stain the biological sample examined. Immunohistochemical stains are in many cases referred to in the scientific literature as immunostains, immunocytostains, immunohistopathological stains, etc.

As used herein in the specification and in the claims section below, the term “histological stain” refers to any colorant, reaction and/or associated reagents used to stain cells and tissues in association with cell components such as types of proteins (acidic, basic), DNA, RNA, lipids, cytoplasm components, nuclear components, membrane components, etc. Histological stains are in many cases referred to as counterstains, cytological stains, histopathological stains, etc.

As used herein in the specification and in the claims section below, the term “DNA ploidy stain” refers to stains which stoichiometrically bind to chromosome components, such as, but not limited to, DNA or histones. When an antibody is involved, such as anti-histone antibody, such stains are also known as DNA immunoploidy stains.

As used herein in the specification and in the claims section below, the phrase “nucleic acid sequence specific probe” refers to polynucleotides labeled with a label moiety which is either directly or indirectly detectable, which polynucleotides being capable of base-pairing with matching nucleic acid sequences present in the biological sample.

Lists of known stains are provided in U.S. Pat. No. 6,007,996, filed Jul. 27, 1998, the contents of which are hereby incorporated by reference.

Representative examples of biological element that response differently to a staining procedure and which are identifiable by their structure according to some embodiments of the present invention, include nuclear matter, cytoplasm matter, erythrocytes, leukocytes, tissue elements (e.g., glands, ducts, lobules, stroma, adipose tissue, blood vessels, hair, fibroblasts, macrophage, neutrophils, necrotic areas, granulomas) and the like.

In some embodiments of the invention the method identifies a structure of at least one biological element which is stainable by a target-specific stain. For example, the method of the present embodiments can identify structure of a specific protein, a chromosomal sequence, or other objects such as, but not limited to, specific bacteria (e.g., Bacilli, such as mycobacteria, fungi, viruses).

Thus, the present embodiments provide a “virtual staining” procedure according to which one or more sections of the biological sample are presented in color even when they are not stained.

In various exemplary embodiments of the invention the identification of the structures is performed on imagery data corresponding to an image of a relatively low magnification. It was found by the inventors of the present invention that structures of many biological elements can be identified from images having a magnification of less than 60 fold, more preferably less than 40 fold, more preferably less than 20 fold, say about 10 fold magnification or less.

The use of relatively low magnification is advantageous since it allows better identification of groups of picture-elements having similar grey-levels or other attributes. It is to be understood, however that although the processing preferably takes place at relatively low magnification, the color-coded image displaying the identified elements can be provided at higher magnification. This can be done by stretching the color coded image while maintaining the shape of the identified element. When the input image is captured through an automatic microscope with coordinate registration, digitally duplication of picture-elements can be employed for displaying color-coded image at a higher magnification. Such transformations from low magnification to high magnification are well known to those skilled in the art of image processing.

The identification of structures according to some embodiments of the present invention is based on morphology and orientations of groups of picture-elements in the imagery data. In some embodiments of the present invention the identification of structures is also based on spatial locations of groups of picture-elements within the image. The locations are typically relative to the locations other groups of picture-elements in the image, but may also be absolute locations.

The method of the present embodiments can also calculate various intensity-related quantities among groups of picture-elements and use the calculated quantities for the purpose of identification the structures. Representative examples of intensity-related quantities suitable for the present embodiments, include, without limitation, moments of the intensity distribution, intensity smoothness, intensity gradients, average intensity, and the like.

In various exemplary embodiments of the invention the method performs non-local comparison between groups of picture-elements in the imagery data for the purpose of the identification. Such comparison can be based on spatial features (e.g., morphology, orientation) and/or intensity-related features (e.g., intensity distribution, intensity smoothness, average intensity, etc.).

In various exemplary embodiments of the invention the method accesses a library of structures for the purpose of the identification. For example, once the method determines that a group of picture-elements potentially corresponds to a structure of a biological element, the method can declare the structure of the group a query structure, access the library and compare the query structure to entries in the library. Such comparison can include various transformations such as rotations and stretching so as to establish conformity between the query structure and the library entry.

The identification of structures according to some embodiments of the present invention can include one or more of the following procedures: edge detection, local edge enhancement, clustering, upwind scheme discretization and fast marching. These procedures are known to those skilled in the art of image processing.

Thus, for example, edge detection can be employed using a global gradient filter and a fixed or varying threshold. The detected edges can be locally enhanced, e.g., by employing the Canny procedure [Canny, J. (1986), “A computational approach to edge detection,” IEEE Transactions on Pattern Analysis and Machine Intelligence 8(6): 679-698].

Clustering can be employed so as to dissociate grey-levels into classes which can be later used for the identification of structures and shapes. Any clustering technique known in the art can be employed, including, without limitation, K-means algorithm, scale-space clustering, Potts-spins method and the like. The clustering can be used to. An active contour technique can be applied on selected regions in the image according to their grey level, contrast, etc., for example, as disclosed in Amir, A. and Lindenbaum M. (1998), “Quantitative Analysis of Grouping Processes,” IEEE Trans. on PAMI 20(2): 168-185.

For the specific task of finding and defining arches and arc-lets that compose biological elements upwind schemes can be used for identifying the flow of lines and other structures. Also contemplated is the use of fast marching algorithms or level set methods for defining element closures. For example, element closures can be defined by employing the techniques disclosed in Kimmel, R. and Bruckstein, A. M. (2003), “On regularized Laplacian zero crossings and other optimal edge integrators,” Int. Journal of Computer Vision 53(3): 225-243.

Further contemplated is the use of iterative schemes for arch closures by employing local variations on the thresholds of one or more of the above techniques. The variations can be discrete or continues, as desired. The stopping criterion for identification of a structure according to various exemplary embodiments of the present invention is background level crossing [Shashua, A. and Ullman S. (1991), “Grouping Contours by Iterated Pairing Network,” Neural Info. 3: 335-341).

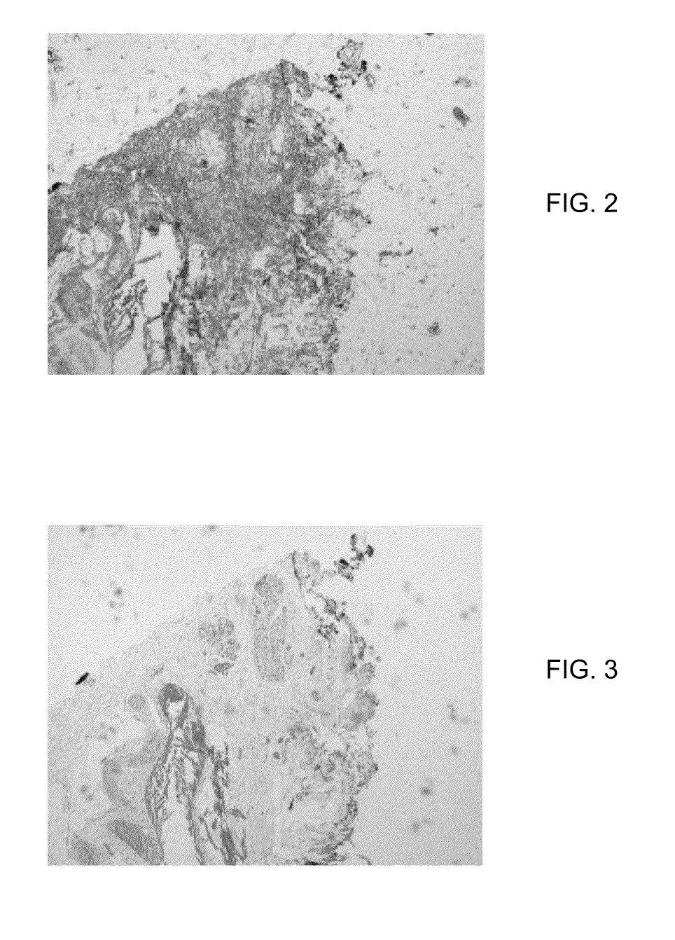

Reference is now made to FIGS. 2 and 3 which are images of a paraffin embedded breast tissue specimen. FIG. 2 is a grey-scale transmission image of the specimen without staining, and FIG. 3 shows a serial section of the specimen following staining by Hematoxylin and Eosin. As shown, the staining allows identification of nuclei and tissue elements, such as ducts, lobules and the like. The staining also affects the transparency of the biological elements and the intensities of the pixels.

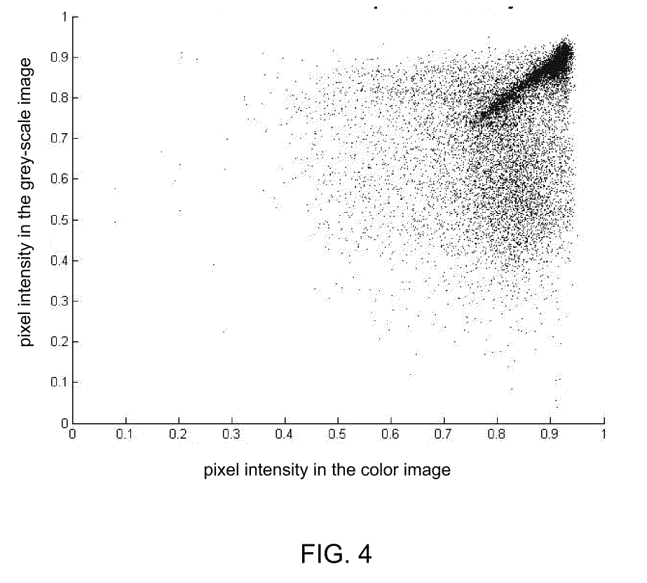

FIG. 4 is scatter plot demonstrating the pixel intensity mapping between the grey-scale image and the color image. The intensity values in FIG. 4 are in units which are normalized to 1. As shown there is a non-monotonic mapping between the images, whereby some high intensity pixels in the grey-scale image are mapped to low intensity pixels of the color image and vice versa. This non-monotonic mapping is due to the variation in transparency caused by the stain. In the present example (breast tissue) the nuclear matter is more transparent in the visual range than cytoplasm matter. However, when stained by Hematoxylin and Eosin, the cytoplasm becomes more transparent than nuclei.

The present embodiments successfully overcome the problem of non-monotonic mapping by employing a procedure which is other than mapping of grey-levels to hues. In this respect, the method of the present embodiments employs various non-local comparisons for the purpose of identifying structures, as further detailed hereinabove.

The present embodiments also contemplate the inclusion of additional information in the identification of structures of biological element.

Such additional information can comprise input regarding the type of biological sample which is under investigation and the biological elements and structures expected to be present in the sample. For example, when the biological sample is a tissue specimen, the additional information can comprise input regarding the type of tissue and whether or not some pathologies and/or abnormalities are expected to be present in the sample. It is recognized that in many practical case such input is available since the imaging of biological samples, and particularly tissue sample, is typically performed after some preliminary observations regarding the condition of the sample.

Thus, according to various exemplary embodiments of the present invention the method uses prior knowledge regarding typical structures of biological elements present in the biological sample. As a representative example, consider a breast tissue for which there exists prior knowledge that ducts, lobules, connecting tissue (stroma) and fat tissue are present. The method of the present embodiments can use a reference shape of, e.g., a duct section for identifying groups of picture-elements representing ducts in the biological sample. Reference shapes and/or structures of other biological elements can also be used for the identification of groups of picture-elements representing such elements in the sample. The reference shapes and/or structures can be obtained from a library or a reference image. The present embodiments also contemplate identification based on partial match (e.g., within 70% or within 80% or within 90%) between the shape as determined from groups of the picture-elements in the imagery data and the shape as obtained from the library.

FIGS. 2, 3, 5 and 6 demonstrate a procedure for incorporating prior knowledge regarding typical structures of biological elements, according to some embodiments of the present invention.

FIG. 3 is a reference image which is used for extracting reference shapes and structures of biological elements present therein. In the present example, the reference image is a color image of a breast tissue stained with H&E, but it is to be understood that other reference images (e.g., of other biological samples, and/or stained with other stains) can also be used. Preferably, the biological sample (breast tissue in the present example) in the reference image is of the same type as the biological sample under investigation. However, this need not necessarily be the case. For some applications, it may not be necessary for the biological sample to be of the same type, since the same biological elements can be present in different types of biological sample.

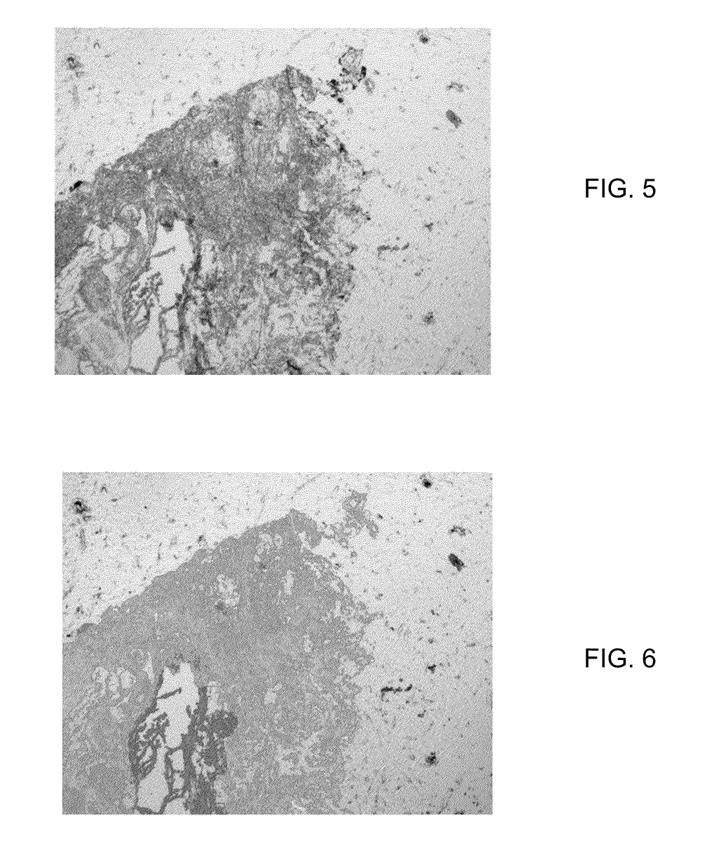

FIG. 2 is a grey-scale transmission image corresponding to imagery data inputted by the method of the present embodiments. The image was captured by a grey-scale imaging device. In the present example, the input image is of a non-stained breast tissue. FIG. 5 is a grey-scale image of the same non-stained breast tissue shown in FIG. 2, but captured with a color imaging device.

The imagery data corresponding to the reference image (FIG. 3) was analyzed in accordance with some embodiments of the present invention to extract reference shapes of various biological elements present therein. The input imagery data (corresponding to FIG. 2) was processed according to some embodiments of the present invention, and shapes formed by groups of picture-elements were compared to the reference shapes. Matching shapes were identified as biological elements.

FIG. 6 is a color-coded image in which the imagery data corresponding to FIG. 2 is displayed such that different types of biological elements are presented in different colors. The color pallet was selected to imitate the colors of H&E. As demonstrated, the method of the present embodiments successfully identified structures of biological elements that would have been enhanced had the biological sample been stained by H&E.

While the embodiments above are described with a particular emphasis to the combination grey level data with additional biological information, it is to be understood that more detailed reference to such combination is not to be interpreted as limiting the scope of the invention in any way. In some embodiments of the present invention the structures of the biological element are identified without the additional biological information. For example, in some embodiments the identification is based only on grey level data. Several examples for the identification of structures of the biological element without additional biological information are described hereinbelow.

In some embodiments of the present invention, the method obtains additional imagery data and uses the additional imagery data for correcting the identification of structures. These embodiments are particularly useful when the number of false positive identifications is high. For example, reflections from paraffin or minute debris can result in erroneous identification, fat tissue can reflect light in different ways and pronounce features that appear dim on stained samples, etc.

The additional imagery data can comprises phase microscopy imagery data, dark field imagery data, inverted microscopy imagery data and the like. In phase microscopy, for example, the difference in refractive index between different biological elements can result in different degrees of optical interference, which translate to different grey-levels [Curl et al. (2004), “Quantitative phase microscopy: A new tool for investigating the structure and function of unstained live cells,” Clinical and Experimental Pharmacology and Physiology 31(12): 896-901]. The appearance of phase images depends on the parameters of the annular ring through which the light passes, since different ring diameters pronounce different refractive indices according to the resultant optical path differences.

The additional imagery data is used for extracting additional information to be used as an input to the rules by which the intensities are translated to colors. When phase images are used, a few phase rings are employed so as to gain more information. It is appreciated that imagery data which correspond to several rings is spanned over a multi-dimensional grey-level space of n+1, where n is the number of phase rings that are used.

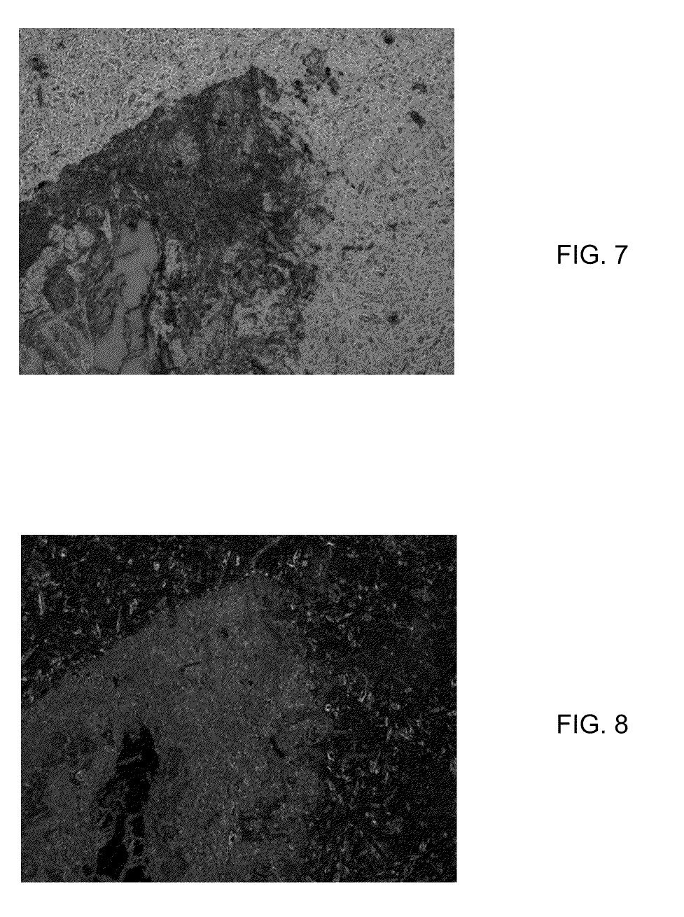

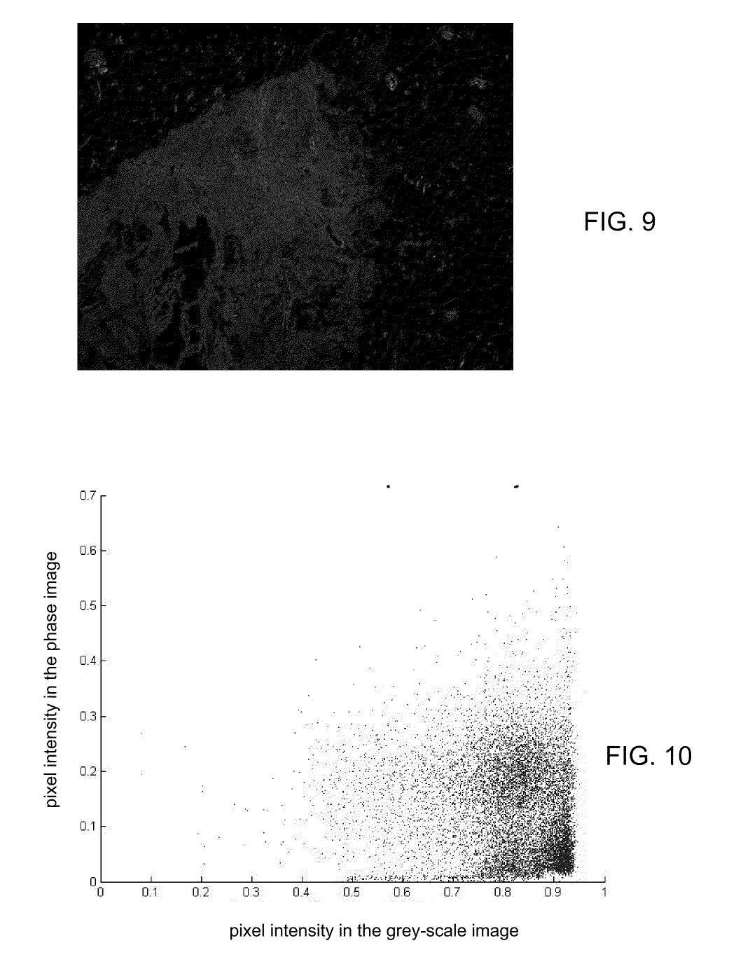

FIGS. 7-9 are three phase images of the breast tissue sample of FIG. 2, as acquired using a U-PCD2, OLYMPUS Phase contrast condenser annular rings Nos. I, II and III, respectively. FIG. 10 is a scatter plot demonstrating the relation between pixel intensities in the grey-scale image and the pixel intensities in the phase image. The intensity values in FIG. 10 are in units which are normalized to 1. The non-monotonic relation is vivid: bright regions on the transmission image are mapped to relatively dark regions on the phase image.

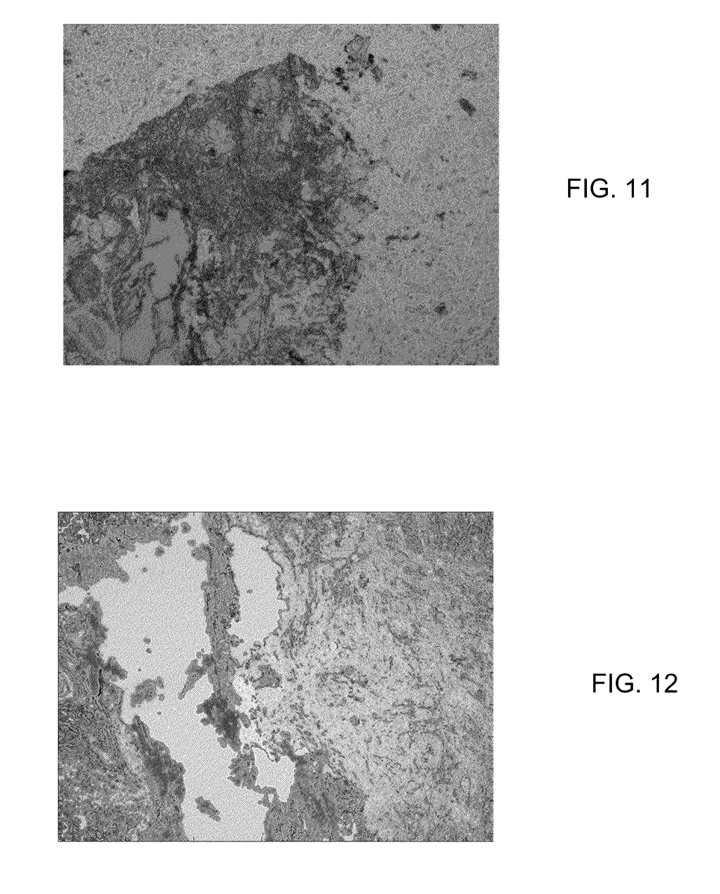

FIG. 11 is an illustrative example of the embodiment in which additional imagery data is combined with the input data. In the present example, two phase images (I and II) were used as additional imagery data and were combined with the data acquired using a grey-scale imaging device (see FIG. 2). Thus, the additional imagery data spanned over a three-dimensional space (one dimension spanned by the grey-scale data, and two additional dimensions spanned by the two phase images), which was successfully mapped into an RGB color space.

The artificial color space can be used to pronounce the relevant and irrelevant regions of the sample. In the example shown in FIG. 11, the paraffin fingerprints are displayed in orange hue surrounding the tissue, ducts are displayed in light pink hue (shown surrounded by dark purple) and erythrocytes are displayed in dark hue. Regions of less or no interest can be removed from the final display. For example, the paraffin fingerprints can be eliminated based on their characteristic texture and location. The same procedure can be employed for other biological elements, such as fatty tissue (see the yellow/red surroundings of the main purple region in FIG. 11) and the like.

FIG. 12 is another illustrative example of the embodiment in which additional imagery data is combined with the input data. Similarly to FIG. 11, two phase images (I and II) were used as additional imagery data. The difference between FIG. 12 and FIG. 11 is type of which was used mapping to the color space.

In various exemplary embodiments of the invention the additional imagery data comprises imagery data captured following staining of the biological sample, wherein the identification of structures comprises identifying a structure of at least one biological element which is not enhanced or targeted by the staining. This embodiment is particularly useful when it is desired to use combine the additional imagery data with the virtually stained data at the level of the display device. Thus, in some embodiments of the present invention the color-coded (virtually stained) image is displayed together with the physically stained image in a superimposed manner and at the same magnification level.

One example of additional imagery data is data acquired by FISH technique which is the process of marking with a fluorescent moiety conjugated to a specific nucleic acid molecule complementary to an examined chromosome region (collectively referred herein as a probe), followed visualization of the fluorescent moiety by fluorescence microscopy. This technique is routinely employed in the field of biomedicine mainly due to the large amount of information that may be gained in a single test.

While the embodiments below are described with a particular emphasis to FISH as the source of additional imagery data, it is to be understood that more detailed reference to FISH is not to be interpreted as limiting the scope of the invention in any way.

Certain diseases and disorders, including many cancers and birth defects, are genetic disorders caused by defects in one or more genes. Many other diseases are known or believed to have a genetic component(s), that is, there exists genetic defect(s) that does not alone cause the disease but contributes to it, or increases the probability of developing the disease later in life, phenomena known in the art as multifactorial diseases and genetic predispositions. Correlation of visible genetic defects with known diseases allows doctors to make definitive diagnoses, and permit early detection and treatment of many diseases. Genetic counseling can alert prospective parents and at-risk individuals to the possibility of potentially serious medical problems in the future, permitting appropriate intervention. Many genetic diseases, such as for example cystic fibrosis (CF) and others, are caused by small defects (e.g., mutations involving addition, deletion or substitution of only one or a few nucleotides), which are not detectable by chromosomal banding techniques but are detectable by FISH. Over the years, FISH techniques have been improved by the development of powerful immunological probes, a growing variety of excellent fluorescent dyes for microscopy and spectroscopy, and dramatic improvements in the objectives, illuminators and filters used for fluorescence microscopy.

The power and utility of FISH is due to many factors: (i) FISH can be used not only on isolated chromosomes and nuclei, but also whole cells within fixed, paraffin-embedded tissue sections; (ii) it can detect relatively small defects (ability of detecting smaller defects being constantly increased); (iii) it can provide results relatively quickly; (iv) its moderate cost allows it to be used in most diagnostic and research laboratories; (v) adaptation can be developed for various probes and specimen types; and, (vi) high specificity and sensitivity can be achieved (vii) within a short throughput, typically two hours.

In very early stages of some cancers, long before the cells are recognizably abnormal, there may be an increase in the number of specific genes, phenomenon known in the art as gene amplification, that are detectable using locus-specific probes. Using FISH to detect chromosome abnormalities in cancerous cells may point out the developmental stage the disease have reached and therefore to select the most suitable treatment(s), many of which are stage specific in their effectiveness. Thereby precious time is saved and patients suffering is minimized, selecting the most effective stage specific treatment.

In some FISH applications, a visual inspection (through the eyepieces of a microscope or at an image on a monitor) is sufficient to determine whether a fluorescent label is present or absent, for somewhat more complex specimens, the colored labels are counted. FISH can provide information on the location of the labeled probe, the number of labeled sites on each chromosome, and the intensity of labeling (the amount of genetic material) at each site. Centromeric (repetitive DNA) probes and chromosome paints are used to tag and count the number of copies present of each targeted chromosomes. Locus-specific probes are used to map the location of small regions of genetic material. These types of probes can be used on intact interphase nuclei as well as metaphase chromosome spreads, and can be counted visually or automatically by a suitable algorithm.

It is frequently desirable to count the FISH signals preferentially at specific locations on the tissue section. For example, FISH is oftentimes used for the detection of tumor amplification, by detecting amplification level of a particular DNA sequence. In such cases it is desirable to identify the tumor region and to assess the amplification level at this particular region. However, identification of a tumor region from the FISH specimen is not possible, since such identification is based on morphological features which are absent from the FISH specimen. The traditional practice is therefore to stain a serial section of the specimen for the purpose of identifying the region-of-interest. Due to conflicting physical and chemical requirements between the stain and the fluorescent moiety of the FISH, the stained section cannot be used for FISH and is therefore kept as a reference section. FISH is applied to a separate section and the region-of-interest for counting is defined on the FISH image based on the reference section.

The present embodiments successfully provide a procedure for combining information acquired from staining with information acquired from achromatic imagery data.

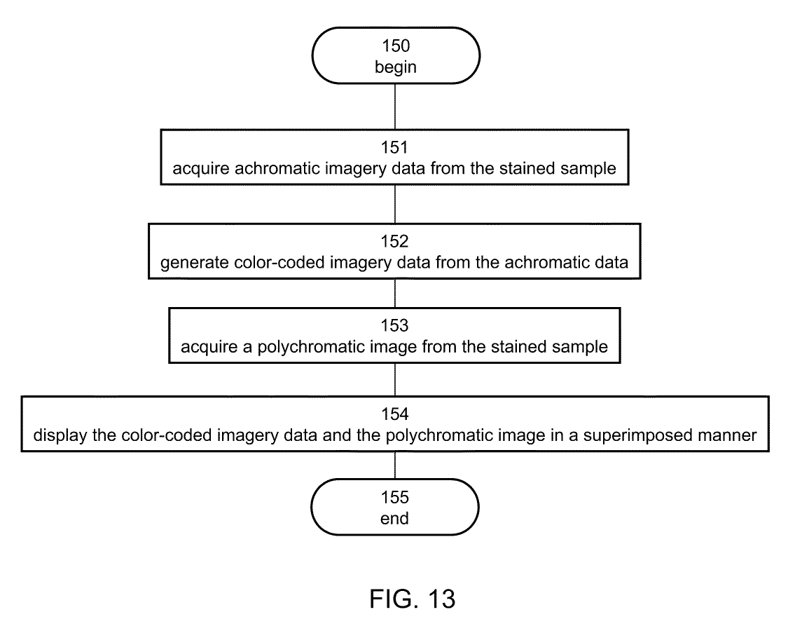

The procedure is described in the flowchart diagram of FIG. 13. It is to be understood that, unless otherwise defined, the procedure described hereinbelow can be executed in any orders of execution. Specifically, the ordering of the flowchart diagram is not to be considered as limiting. Additionally, several operations of the procedure described below are optional and may not be executed.

The procedure begins at 150 and continues to 151 at which achromatic imagery data are acquired from a stained biological sample. The stained sample can be a specimen dyed by FISH as further detailed hereinabove.

The achromatic imagery data can be obtained, for example, by capturing a bright-field (transmission) image of the sample. In various exemplary embodiments of the invention the bright-field image is captured at relatively low magnification. When the sample is stained by fluorescence, the bright-field image is preferably captured at short exposure so as not to bleach the fluorescent signals. The achromatic imagery data can include data from more than one image. For example, beside bright-field data, the achromatic imagery data can comprise at least one of: phase microscopy imagery data, dark field imagery data and inverted microscopy imagery data.

The procedure continues to 152 at which color-coded imagery data is generated from the achromatic data. The coloring of the data is according to structures of biological elements identified in the achromatic data, and can be done, for example, by executing selected operations of the method described above with reference to FIG. 1. The color-coded imagery data thus correspond to a virtually stained image.

The procedure optionally continues to 153 at which a polychromatic image is acquired from the stained biological sample. In various exemplary embodiments of the invention the polychromatic image is captured at relatively high magnification. Typically, the magnification of the polychromatic image is at least 4 times, more preferably at least 10 times, more preferably at least 20 times higher than the magnification of achromatic image. The polychromatic image can be captured by spectral imaging, whereby the spectrum of the light is measured at a plurality of gridwise arranged spatial locations over the sample. When the stained sample is a specimen dyed by FISH, the polychromatic image is captured by illuminating the sample with fluorescent illumination, and analyzing the fluorescent signals emitted from the sample. In various exemplary embodiments of the invention the technique used at 153 for acquiring the polychromatic image differs from the technique used at 151 above for acquiring the achromatic imagery data.

The procedure continues to 154 at which an image corresponding to the color-coded data and the polychromatic image are displayed together in a superimposed manner and at the same magnification level. Typically, the images are displayed at the magnification at which the polychromatic image was acquired, since this magnification is typically higher and therefore provides more details. The superimposing typically involves some coordinate transformation (translation, rotation, stretching, etc.), which can be applied as known in the art. The data can be displayed using any display device, include, without limitation, a computer screen, an eyepiece (e.g., a microscope eyepiece) a projector and a printer.

Optionally, the virtually stained image (corresponding to the color-coded data) is transmitted to a microscope eyepiece during the inspection of the stained biological sample under the microscope objective. In this embodiment, the virtually stained image is subjected to a coordinate transformation so as to match the magnifications of the virtually stained image and the scene within the field-of-view of the microscope and to superimpose them. Preferably, the coordinate transformation is applied dynamically and synchronously with any motion of the microscope stage.

In some embodiments of the present invention the procedure allows toggling between a view of a single image or scene and a superimposed view of two images or an image and a scene.

The procedure ends at 155.

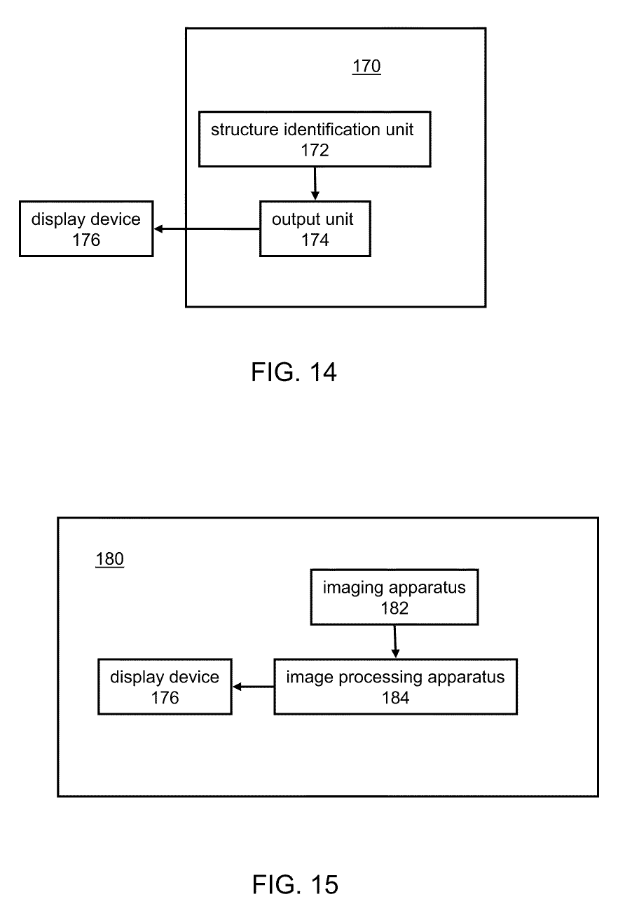

Reference is now made to FIG. 14 which is a schematic illustration of an apparatus 170 for analyzing imagery data pertaining to a biological sample, according to various exemplary embodiments of the present invention. Apparatus 170 can be used for executing at least a few of the operations of the method or procedure described above. Apparatus 170 comprises a structure identification unit 172 and an output unit 174. structure identification unit 172 identifies structures of biological elements in the imagery data based on achromatic intensity values of the imagery data, as further detailed hereinabove. Output unit 174 is configured for displaying the imagery data as a color-coded image on a display device 176, as further detailed hereinabove.

FIG. 15 is a schematic illustration of an imaging system 180, according to various exemplary embodiments of the present invention. System 180 comprises an imaging apparatus 182 which is configured for acquiring an achromatic image of a biological sample, and an image processing apparatus 184 configured for processing imagery data corresponding to the achromatic image and generating a color-coded image wherein at least two different types of biological elements in are presented in different colors. In various exemplary embodiments of the invention the principles and operations of apparatus 184 are similar to the principles and operations of apparatus 170. In various exemplary embodiments of the invention apparatus 184 is apparatus 170. System 180 can also comprise a display device 176 for displaying the color-coded image generated by apparatus 184 or 170.

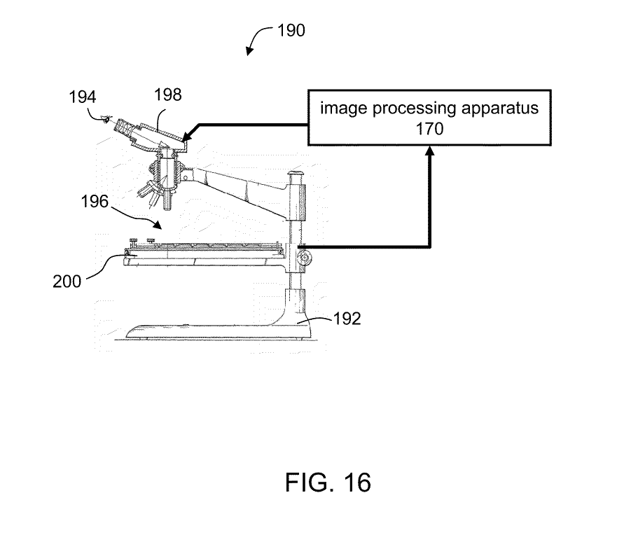

FIG. 16 is a schematic illustration of microscope system 190, according to various exemplary embodiments of the present invention. Microscope system 190 comprises a microscope device 192 for providing the eye 194 of a user (not shown) with an enlarged view of a scene or part thereof, generally shown at 196. Microscope system 190 further comprises an image processing apparatus, such as apparatus 174. The image processing apparatus transmits a color-coded image to an eyepiece 198 of microscope device 192 in a manner such that color-coded image superimposes the view of scene 196. The color-coded image shows at least two different types of biological elements in different colors, as further detailed hereinabove. In some embodiments of the present invention apparatus 170 applies coordinate transformation to the color-coded image synchronously with a motion of a stage 200 of microscope device 192. Thus, image processing apparatus 170 preferably receives position data from stage 200.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of analyzing imagery data pertaining to a biological sample, comprising:
identifying structures of biological elements in the imagery data based on achromatic intensity values of the imagery data; and
displaying the imagery data as a color-coded image, wherein at least two different types of biological elements in said color-coded image are presented in different colors.

2. The method of claim 1, further comprising acquiring an achromatic image of a biological sample, thereby providing the imagery data.

3. Apparatus for analyzing imagery data pertaining to a biological sample, comprising:
a structure identification unit, for identifying structures of biological elements in the imagery data based on achromatic intensity values of the imagery data; and
an output unit being associated with a display device and configured for displaying the imagery data as a color-coded image on said display device, wherein at least two different types of biological elements in said color-coded image are presented in different colors.

4. An imaging system comprising an imaging apparatus configured for acquiring an achromatic image of a biological sample, and the apparatus of claim 3.

5. A microscope system, comprising a microscope device for providing a user with an enlarged view of a scene, and the apparatus of claim 3, wherein said output unit is configured to transmit said color-coded image to an eyepiece of said microscope device in a manner such that said color-coded image superimposes said view of said scene.

6. The system of claim 5, wherein said output unit is configured to apply coordinate transformation to said color-coded image synchronously with a motion of a stage of said microscope device.

7. The method of claim 1, wherein said identification of said structures comprises identifying a structure of at least one biological element that would have been enhanced had the biological sample been stained.

8. The method of claim 1, wherein said identification of said structures comprises identifying a structure of at least one biological element which is stainable by a target-specific stain.

9. The method of claim 1, wherein said identification of said structures is based on morphology and orientations of groups of picture-elements in the imagery data.

10. The method of claim 1, wherein said identification of said structures is based on non-local comparison between groups of picture-elements in the imagery data.

11. The method of claim 1, wherein said identification of said structures is based on moments of the intensity distribution among groups of picture-elements in the imagery data.

12. The method of claim 1, wherein said identification of said structures is based on intensity smoothness among groups of picture-elements in the imagery data.

13. The method of claim 1, wherein said identification of said structures is based on intensity gradients among groups of picture-elements in the imagery data.

14. The method of claim 1, wherein said identification of said structures is based on comparison of shapes formed by group of picture-elements in the imagery data to reference shapes of biological elements.

15. The method of claim 14, wherein said reference shapes are obtained from a library of shapes.

16. The method of claim 14, wherein said reference shapes are obtained from reference imagery data corresponding to a reference image.

17. The method of claim 16, further comprising extracting said reference shapes from said reference imagery data.

18. The method of claim 16, further comprising capturing said reference image.

19. The method of claim 1, wherein said identification of said structures comprises at least one procedure selected from the group consisting of: edge detection, local edge enhancement, clustering, upwind scheme discretization and fast marching.

20. The method of claim 1, further comprising obtaining additional imagery data and using said additional imagery data for correcting said identification of said structures.

21. The method of claim 20, wherein said additional imagery data comprises phase microscopy imagery data.

22. The method of claim 20, wherein said additional imagery data comprises dark field imagery data.

23. The method of claim 20, wherein said additional imagery data comprises inverted microscopy imagery data.

24. The method of claim 20, wherein said additional imagery data comprises imagery data captured following staining of the biological sample, and wherein said identification of said structures comprises identifying a structure of at least one biological element which is not enhanced or targeted by said staining.

25. The method of claim 20, further comprising capturing an image of the biological sample so as to provide the additional imagery data.

26. The method of claim 1, wherein said color-coded image is displayed at a magnification level which is higher than a magnification at which said identification of said structures is performed.

27. The method of claim 1, wherein said color-coded image is displayed together with an image captured following staining of the biological sample in a superimposed manner and at the same magnification level.
